(19) United States
(12) Patent Application Publication
(10) Pub. No.: US 2014/0267006 A1
(43) Pub. Date: Sep. 18, 2014

(54) AUTOMATIC DEVICE DISPLAY ORIENTATION DETECTION

(71) Applicants: Giuseppe Raffa, Portland, OR (US); Chieh-Yih Wan, Beaverton, OR (US)

(72) Inventors: Giuseppe Raffa, Portland, OR (US); Chieh-Yih Wan, Beaverton, OR (US)

(21) Appl. No.: 13/834,262

(22) Filed: Mar. 15, 2013

(51) Int. Cl. G06F 3/00

(52) U.S. Cl. CPC G06F 3/005
USPC 345/156

(57) ABSTRACT

The present disclosure provides techniques for automatically changing device display orientation. A computing device includes a display and an inertial measurement unit (IMU) to detect changes in computing device orientation. The computing device also includes a driver to change an orientation of the display when a change in orientation of the computing device is detected by the IMU. A camera can be used to track user eye position in response to detection of a change in orientation of the computing device by the IMU.

### TECHNICAL FIELD

The present invention relates to mobile devices. In particular, the present invention relates to orientating the display of mobile devices.

### BACKGROUND

Mobile devices can be held in a variety of ways and oriented in multiple directions. The display of a mobile device is oriented based on the orientation of the mobile device. Currently, automatic display orientation is based on an accelerometer reading and the assumption that the user is looking at the display in the natural orientation of the body subjected to gravity.

### BRIEF DESCRIPTION OF THE DRAWINGS

Certain exemplary embodiments are described in the following detailed description and in reference to the drawings, in which:

FIG. 1 is a block diagram of a computing device;

FIG. 2 is a block diagram of an example of a system for orienting a display;

FIG. 3 is an illustration of a change in display orientation;

FIG. 4 is an illustration of a display orientation in relation to a user position;

FIG. 5 is an illustration of a change in display orientation;

FIG. 6 is a process flow diagram of a method of orienting a display; and

FIG. 7 is a process flow diagram of a method of orienting a display.

### DETAILED DESCRIPTION OF SPECIFIC EMBODIMENTS

Embodiments disclosed herein provide techniques for automatically orienting a device display. Current techniques for automatically orienting a device display rely on an accelerometer reading. However, the current technique is only effective when the device is in a vertical position. When the device is in a horizontal position, gravity will not cause any effect on the accelerometer reading to trigger an appropriate change in device display orientation. However, by employing detection devices such as a compass and a gyrometer in addition to the accelerometer, changes in device orientation can be detected, regardless of whether the device is in a vertical position or a horizontal position. A camera can be used to detect user face contour and/or eye position in response to a detection of a change in device orientation. By employing a camera in addition to the detection devices, changes in device orientation, or a lack of changes in device orientation, can be detected, even if the user is in a horizontal position, or changes position from vertical to horizontal.

FIG. 1 is a block diagram of a computing device 100. The computing device 100 may be, for example, a laptop computer, tablet computer, mobile device, or cellular phone, such as a smartphone, among others. The computing device 100 can include a central processing unit (CPU) 102 that is configured to execute stored instructions, as well as a memory device 104 that stores instructions that are executable by the CPU 102. The CPU 102 can be coupled to the memory device 104 by a bus 106. Additionally, the CPU 102 can be a single core processor, a multi-core processor, or any number of other configurations. Furthermore, the computing device 100 can include more than one CPU 102.

The computing device 100 can also include a graphics processing unit (GPU) 108. As shown, the CPU 102 can be coupled through the bus 106 to the GPU 108. The GPU 108 can be configured to perform any number of graphics operations within the computing device 100. For example, the GPU 108 may be configured to render or manipulate graphics images, graphics frames, videos, or the like, to be displayed to a user of the computing device 100. In some embodiments, the GPU 108 includes a number of graphics engines, wherein each graphics engine is configured to perform specific graphics tasks, or to execute specific types of workloads.

The memory device 104 can include random access memory (RAM), read only memory (ROM), flash memory, or any other suitable memory systems. For example, the memory device 104 may include dynamic random access memory (DRAM). The CPU 102 can be linked through the bus 106 to a display interface 110 configured to connect the computing device 100 to a display device 112. The display device 112 can include a display screen that is a built-in component of the computing device 100. The display device 112 can also include a computer monitor, television, or projector, among others, that is externally connected to the computing device 100.

The CPU 102 can also be connected through the bus 106 to an input/output (I/O) device interface 114 configured to connect the computing device 100 to one or more I/O devices 116. The I/O devices 116 can include, for example, a keyboard and a pointing device, wherein the pointing device may include a touchpad or a touchscreen, among others. The I/O devices 116 can be built-in components of the computing device 100, or can be devices that are externally connected to the computing device 100.

A network interface card (NIC) 118 can be adapted to connect the computing device 100 through the system bus 106 to a network (not depicted). The network (not depicted) may be a wide area network (WAN), local area network (LAN), or the Internet, among others. In an example, the computing device 100 can connect to a network via a wired connection or a wireless connection.

The computing device 100 also includes a storage device 120. The storage device 120 is a physical memory such as a hard drive, an optical drive, a thumbdrive, a secure digital (SD) card, a microSD card, an array of drives, or any combinations thereof, among others. The storage device 120 can also include remote storage drives. The storage device 120 includes any number of applications 122 that are configured to run on the computing device 100.

The computing device 100 includes an inertial measurement unit (IMU) 124. The IMU 124 measures the movement of the computing device 100. In particular, the IMU 124 measures the pitch, roll, and yaw of the computing device 100. Pitch, roll, and yaw are measured in reference to the typical vertical position as the starting position. The typical vertical position can refer to the position at which the device has a pitch, yaw, and roll of zero. In embodiments, the typical vertical position of a cell phone can refer to the position at which the cell phone has an ear speaker at the top most portion of the device and a microphone at the bottom most portion of the device. Furthermore, in embodiments, the typical vertical position of a tablet device can refer to the position at which the tablet device has a camera lens at the top most portion of the device, and user controls at the bottom most portion of the device. When the data collected by the IMU 124 indicates a change in computing device orientation, such as more than a predefined threshold, a corresponding change in display orientation is triggered, or the camera is activated to double check the real relative orientation of the device with respect to the user.

The block diagram of FIG. 1 is not intended to indicate that the 100 is to include all of the components shown in FIG. 1. Further, the mobile device 100 may include any number of additional components not shown in FIG. 1, depending on the details of the specific implementation.

FIG. 2 is a block diagram of a system 200 for orienting a display. The system 200 is included in a computing device, such as computing device 100. The system 200 includes an inertial measurement unit (IMU) 202. The IMU 202 may the same as the IMU 124 discussed with respect to FIG. 1. The IMU 202 includes three devices, a compass 204, an accelerometer 206, and a gyrometer 208. Using the three devices 204, 206, and 208, the IMU 202 is able to measure three angles, pitch, roll, and yaw, (i.e. rotation about the x, y, and z axes) of the computing device, resulting in a six degree of freedom (6DOF) or nine degree of freedom (9DOF) algorithm.

With a 6DOF algorithm, the pitch, roll, and relative yaw of the device are measured and used to compute a change in orientation of the device. In other words, translation in three perpendicular axes is measured and used to compute a change in orientation of the device. Specifically, pitch refers to the forward and backward inclination of the device. Yaw refers to the lateral edges of the device rotating to the left and right. Roll refers to the top and bottom edges of the device rotating to the left and the right. With a 9DOF algorithm, the measurements from a three degree of freedom compass (3DOF), a 3DOF accelerometer, and a 3DOF gyroscope are used to calculate the change in orientation of the device with respect to the magnetic North of the earth.

When the IMU 202 detects a rotation of a computing device about an axis greater than a set amount, a camera 210 is triggered. In an example, the set amount can be 20 degrees, 45 degrees, 90 degrees, or any other determined angle. In an example, the set amount can be determined and programmed by a manufacturer, a user, or others. The camera can be turned on at startup when the device is in startup position, i.e. vertical position. While the display is on, the position of the eyes and a face contour is captured and the display is oriented based on the position. The camera can then be turned off until a movement of the device is detected. In this manner, the device power is conserved. Although the IMU 124 is described using a compass, accelerometer, and gyrometer, any device that captures direction, rotation, and acceleration can be used to detect the rotation and movement of the computing device.

The camera 210 is positioned in the housing of the computing device on the face of the computing device such that the camera 210 faces the user during use of the computing device. In an example, the camera is a dedicated camera. In another example, the camera 210 is present on the computing device in addition to at least one other camera present on the computing device. In a further example, the camera is a functioning camera used to take pictures as well as to detect a user's face and/or eye position. The camera can be a still-shot camera, a video camera, a combination still-shot camera and video camera, an infrared camera, a three dimensional camera, or any other type of camera. In embodiments, the camera can be duty cycled such that the camera is powered off until the device detects movement beyond a determined threshold. For example, the camera can be turned on at device startup when the device is at the starting position, i.e. typical vertical position, and capture the user face and/or eye position. The camera can then be turned off until a change in device orientation is detected by the IMU. By duty cycling the camera, power can be saved by not supplying constant power to the camera as the camera is powered off when not in use.

The data collected by the camera 210 is analyzed at face/eyes detection 212. The face/eyes detection 212 analyzes the camera data to determine the position of the user's face and/or eyes in relation to the computing device. The information collected by the IMU 202 and the position of the user's face and/or eyes are transferred to a display rotation decision unit 214. The display rotation decision unit 214 uses the information to determine if the device display should be rotated in accordance with the device orientation to maintain the alignment of the display orientation and the user's eyes. If the display rotation decision unit 214 determines the device display is to be reoriented, the display driver 216 initiates the display reorientation.

In another example, the camera remains on at all times. When the camera is on at all times, the camera tracks the face and/or eyes of the user on a continuing basis. The display orientation is maintained based on the face/eye position.

In a further example, the computing device does not include a camera. The orientation of the device is determined based on data collected by the IMU 202. The orientation of the display is determined based on the device orientation. When the device is vertical, i.e. in portrait position, the current accelerometer-based approach is used. When the device is put on a horizontal surface, the current orientation is considered to be “preserved”. If yaw changes happen when on the horizontal surface, the display is rotated in order to maintain the original orientation.

The block diagram of FIG. 2 is not intended to indicate that the system 200 is to include all of the components shown in FIG. 2. Further, the system 200 may include any number of additional components not shown in FIG. 2, depending on the details of the specific implementation.

FIG. 3 is an illustration of a change in display orientation. The mobile device 302 includes display 304 and camera 306. In the portrait position or general vertical starting position 308, the display is oriented such that the display is up as indicated by arrow 310. When the mobile device 302 is rotated in direction 312 to landscape position 314, the display orientation is also rotated such that upwards on the display is indicated by arrow 316. When held in a vertical position, the rotation of the display is triggered by a typical accelerometer-based algorithm. For example, considering FIG. 3 and a typical orientation system, before movement 312, the accelerometer will be subjected to gravity on the negative Y axis, whereas after the movement, X axis will be subjected to gravity. Hence, mapping those values to a specific display orientation is the typical algorithm being used. When placed in a horizontal position, such as held by a user or placed on a table, the rotation of the display is triggered by the 6DOF algorithm or the 9DOF algorithm.

FIG. 4 is an illustration of a display orientation in relation to a user position. A user 402 is oriented in a vertical position 404, such as sitting in a chair. The user 402 holds the device 406 such that there is a line of sight 408 between the device 406 and the user 402. When the user 402 moves to a horizontal position 410, such as lying on a bed, the line of sight 408 between the user 402 and the device 406 is unchanged. The IMU detects the lack of change in the position of the device, and therefore the lack of change in the line of sight 308, and maintains the orientation of the display from the vertical position 404 to the horizontal position 410. In another example, the IMU may detect a rotation about the horizontal axis and trigger a camera. The camera detects the lack of change in the position of the user eyes, and thus the lack of change in the line of sight 308. In accordance with the lack of change in the position of the user eyes, the orientation of the display is unchanged.

FIG. 5 is an illustration of a change in display orientation. When the device is vertical starting position, i.e. in portrait position, the current accelerometer-based approach is used, in which display orientation is triggered by changes registered by the accelerometer. When the device is held horizontally, such as by a user or a piece of furniture 502, the algorithm will switch to a 6DOF algorithm or 9DOF algorithm to track orientation changes in which the information collected by the IMU 202 triggers changes in display orientation.

When the device 504 is placed on the table 502 in a portrait position 506, the display is orientated such that up is oriented as indicated by arrow 508. When the device is rotated as indicated by arrow 510 to a landscape position 512, the change in orientation is detected by the compass and the gyrometer of the IMU, but no change in accelerometer is detected. Due to the detection of orientation change, the display is rotated such that up within the display is indicated by arrow 514. The change in display rotation can be triggered when a predetermined amount of change in device orientation is detected by the IMU. For example, when the device is rotated at least 90 degrees, the display orientation is changed in accordance with the change in device orientation, but if the device is rotated less than 90 degrees, the orientation of the display is unchanged. The predetermined amount of change can be set by a user or a manufacturer. The predetermined amount of change can be set to any number, such as 30 degrees, 45 degrees, 90 degrees, or any other suitable amount of change.

FIG. 6 is a process flow diagram of a method of orienting a display. At block 602, data is received from the IMU. The IMU measures angles of rotation about the x, y, and z axes of a computing device. To measure the angles of rotation, the IMU includes a compass, an accelerometer, and a gyrometer, resulting in an algorithm with 6 degrees of freedom (DOF) or 9DOF. Additional devices to measure rotation of the computing device may also be included in the IMU. At block 604, the data from the IMU is analyzed for an indication of a change in device orientation. At block 606, the device display is oriented in accordance with the device orientation.

FIG. 7 is a process flow diagram of a method of orienting a display. At block 702, IMU data is received. The IMU data is data from a combination of a compass, an accelerometer, and a gyrometer. At block 704, face and eye detection information is received from a camera. The camera can be triggered by detection by the IMU of a change in device orientation. In another example, the camera can be on and tracking user eye and/or face orientation at all times. At block 706, the IMU and camera data is analyzed for an indication of a change in device orientation. At block 708, the device display is oriented in accordance with the device orientation. The orientation of the device display is changed if a change in device orientation is detected. If no change in device orientation is detected, the orientation of the display is not changed.

Program instructions may be used to cause a general-purpose or special-purpose processing system that is programmed with the instructions to perform the operations described herein. These operations include, but are not limited to, the process flows described in FIG. 6 and FIG. 7. Alternatively, the operations may be performed by specific hardware components that contain hardwired logic for performing the operations, or by any combination of programmed computer components and custom hardware components. The methods described herein may be provided as a computer program product that may include one or more machine readable media having stored thereon instructions that may be used to program a processing system or other electronic device to perform the methods. The term “machine readable medium” used herein shall include any medium that is capable of storing or encoding a sequence of instructions for execution by the machine and that cause the machine to perform any one of the methods described herein. The term “machine readable medium” shall accordingly include, but not be limited to, memories such as solid-state memories, optical and magnetic disks. Furthermore, it is common in the art to speak of software, in one form or another (e.g., program, procedure, process, application, module, logic, and so on) as taking an action or causing a result. Such expressions are merely a shorthand way of stating that the execution of the software by a processing system causes the processor to perform an action or produce a result.

### Example 1

A device is disclosed herein. The device includes logic, at least partially including hardware logic, to receive data from an inertial measurement unit (IMU). The device also includes logic to analyze IMU data for changes in computing device orientation. The device further includes logic to orient a device display in accordance with the computing device orientation.

The device may include logic to receive a user eye position in relation to the device display. The user eye position can be detected by a camera. The camera is triggered by detection of the changes in computing device orientation by the IMU. The camera is triggered when the IMU detects changes in device orientation greater than a predetermined amount. The IMU can include a gyrometer, a compass, and an accelerometer. The device may employ a six degree of freedom (6DOF) algorithm or a nine degree of freedom (9DOF) algorithm. The device may include logic to detect pitch, roll, and yaw of the device.

### Example 2

A system for changing display orientation is described herein. The system includes an inertial measurement unit (IMU) to collect device orientation data. The system also includes a decision engine to analyze the device orientation data to determine changes in device orientation. The system further includes a driver to initiate a change in device display orientation in accordance with a change in device orientation.

The system may include a camera to detect user eyes position. The camera detects user eyes position when a change in device orientation is detected by the IMU. The orientation of the display is changed based on the user eye position. The IMU may include an accelerometer, a gyrometer, and a compass. The system can employ a six degree of freedom (6DOF) algorithm or a nine degree of freedom ((DOF) algorithm. The IMU detects pitch, roll, and yaw of the device. The system detects changes in device orientation when the device is in a horizontal position.

### Example 3

A computing device is described herein. The computing device includes a display and an inertial measurement unit (IMU) to detect changes in device orientation. The computing device also includes a driver to change an orientation of the display when a change in orientation of the computing device is detected by the IMU.

The computing device may include a camera to detect user eye position. The camera detects user eye position when a change in device orientation is detected by the IMU. The driver changes the orientation of the display based on user eye position. The IMU may include an accelerometer, a gyrometer, and a compass. The system can employ a six degree of freedom (6DOF) algorithm or a nine degree of freedom (9DOF) algorithm. The IMU detects pitch, roll, and yaw of the device.

### Example 4

A tangible, non-transitory, computer-readable medium is disclosed herein. The tangible, non-transitory, computer-readable medium includes code to direct a processor to receive data from an inertial measurement unit (IMU). The tangible, non-transitory, computer-readable medium also includes code to direct a processor to analyze IMU data for changes in computing device orientation. The tangible, non-transitory, computer-readable medium further includes code to direct a processor to orient a device display in accordance with the computing device orientation.

In the foregoing description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a mobile platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the inventions. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A device comprising logic, at least partially comprising hardware logic, to:
receive data from an inertial measurement unit (IMU);
analyze IMU data for changes in computing device orientation; and
orient a device display in accordance with the computing device orientation.

2. The device of claim 1, further comprising logic to receive a user eye position in relation to the device display.

3. The device of claim 2, wherein the user eye position is detected by a camera.

4. The device of claim 3, wherein the camera is triggered by detection of the changes in computing device orientation by the IMU.

5. The device of claim 4, wherein the camera is triggered when the IMU detects changes in device orientation greater than a predetermined amount.

6. The device of claim 1, wherein the IMU comprises a gyrometer, a compass, and an accelerometer.

7. The device of claim 1, wherein the device employs a six degree of freedom (6DOF) algorithm or a nine degree of freedom (9DOF) algorithm.

8. The device of claim 1, comprising logic to detect pitch, roll, and yaw of the device.

9. A system for changing device display orientation, comprising:
an inertial measurement unit (IMU) to collect device orientation data;
a decision unit to analyze the device orientation data to determine changes in device orientation; and
a driver to initiate a change in device display orientation in accordance with a change in device orientation.

10. The system of claim 9, wherein the system includes a camera to detect user eye position.

11. The system of claim 10, wherein the camera detects user eye position when a change in device orientation is detected by the IMU.

12. The system of claim 11, wherein the orientation of the display is changed based on the user eye position.

13. The system of claim 9, wherein the IMU comprises an accelerometer, a gyrometer, and a compass.

14. The system of claim 9, wherein the system employs a six degree of freedom (6DOF) algorithm or a nine degree of freedom (9DOF) algorithm.

15. The system of claim 9, wherein the IMU detects pitch, roll, and yaw of the device.

16. The system of claim 9, wherein the system detects changes in device orientation when the device is in a horizontal position.

17. A computing device, comprising:
a display;
an inertial measurement unit (IMU) to detect changes in device orientation; and
a driver to change an orientation of the display when a change in orientation of the computing device is detected by the IMU.

18. The computing device of claim 17, wherein the computing device includes a camera to detect user eye position.

19. The computing device of claim 18, wherein the camera detects user eye position when a change in device orientation is detected by the IMU.

20. The computing device of claim 17, wherein the driver changes the orientation of the display based on user eye position.

21. The computing device of claim 17, wherein the IMU comprises an accelerometer, a gyrometer, and a compass.

22. The computing device of claim 17, wherein the system employs a six degree of freedom (6DOF) algorithm or a nine degree of freedom (9DOF) algorithm.

23. The computing device of claim 17, wherein the IMU detects pitch, roll, and yaw of the device.

24. A tangible, non-transitory, computer-readable medium comprising code to direct a processor to:
receive data from an inertial measurement unit (IMU);
analyze IMU data for changes in computing device orientation; and
orient a device display in accordance with the computing device orientation.
